(19) United States
(12) Patent Application Publication
(10) Pub. No.: US 2018/0253071 A1
(43) Pub. Date: Sep. 6, 2018

(54) WORK SUPPORTING SYSTEM, WORK SUPPORTING METHOD, AND COMPUTER PROGRAM PRODUCT

(71) Applicant: Kabushiki Kaisha Toshiba, Tokyo (JP)

(72) Inventors: Tomohiro YAMASAKI, Bunkyo Tokyo (JP); Hirokazu SUZUKI, Machida Tokyo (JP)

(21) Appl. No.: 15/683,511

(22) Filed: Aug. 22, 2017

(30) Foreign Application Priority Data
Mar. 2, 2017 (JP) 2017-039432

(51) Int. Cl. G05B 19/04

(52) U.S. Cl. CPC G05B 19/04

(57) ABSTRACT

According to an embodiment, a work supporting system includes a specification system, a configuration system, and a decision engine. The specification system is implemented by one or more hardware processors and configured to identify work items from a maintenance log to which a work content is written as text. The configuration system is implemented by one or more hardware processors and configured to establish an anteroposterior relation between the work items based on a clue expression indicating time and the anteroposterior relation in the text within a threshold distance of the work items identified by the specification system. The decision engine is implemented by one or more hardware processors and configured to determine an order relation among the work items based on the anteroposterior relation established by the configuration system.

### CROSS-REFERENCE TO RELATED APPLICATIONS

This application is based upon and claims the benefit of priority from Japanese Patent Application No. 2017-039432, filed on Mar. 2, 2017; the entire contents of which are incorporated herein by reference.

### FIELD

Embodiments described herein relate generally to a work supporting system, a work supporting method, and a computer program product.

### BACKGROUND

Generally known are systems that can search a past maintenance log of maintenance and inspection for equipment, machines, or apparatuses, for example. Full text search systems, for example, provide a keyword and classification information using natural language processing, thereby enabling efficient search. Text mining systems perform analyses using statistical processing or machine learning, for example, thereby considering tendencies of events from various points of view.

Various systems that use text, such as a maintenance log, have been developed, including a system that changes the structure and the order of links of frequently asked questions (FAQ) based on history information, such as the frequency and the field of questions made by users. There has also been developed a mechanism that enables application of a solution for a specific product, version, or problem to a similar product, version, or problem. The mechanism stores therein the states created until the problem is solved, thereby enabling retrieval of the solution based on the states later.

Recent products, however, have been diversified and have shorter life cycles. As a result, manufacturing processes of the products have a number of work items, and the number of work items gradually increases, for example. Consequently, it is difficult to prepare solutions in advance by organizing the work items.

### BRIEF DESCRIPTION OF THE DRAWINGS

FIG. 1 is a diagram of an exemplary entire configuration of a work supporting system;

FIG. 2 is a diagram of an exemplary hardware configuration of a work supporting device;

FIG. 3 is a diagram of an exemplary hardware configuration of a user PC;

FIG. 4 is a diagram of an exemplary configuration of functional blocks in the work supporting system;

FIG. 5 illustrates an example of a maintenance log;

FIG. 6 illustrates an example of a language analysis dictionary;

FIG. 7 illustrates an example of a result of natural language processing;

FIG. 8 illustrates an example of clue expressions indicating the past, the present, and the future;

FIG. 9 illustrates an example of clue expressions indicating an anteroposterior relation;

FIG. 10 illustrates an example of results of setting work items to the past, the present, and the future;

FIG. 11 illustrates an example of results of setting a temporal anteroposterior relation to the work items;

FIG. 12 illustrates an example of a work state database;

FIG. 13 is a flowchart of an example of work item specification performed by the work supporting device;

FIG. 14 is a flowchart of an example of anteroposterior relation setting performed by the work supporting device;

FIG. 15 is a flowchart of an example of order relation determination performed by the work supporting device; and

FIGS. 16A and 16B illustrate output examples of the determined order relation among the work items.

### DETAILED DESCRIPTION

According to an embodiment, a work supporting system includes a specification system, a configuration system, and a decision engine. The specification system is implemented by one or more hardware processors and configured to identify work items from a maintenance log to which a work content is written as text. The configuration system is implemented by one or more hardware processors and configured to establish an anteroposterior relation between the work items based on a clue expression indicating time and the anteroposterior relation in the text within a threshold distance of the work items identified by the specification system. The decision engine is implemented by one or more hardware processors and configured to determine an order relation among the work items based on the anteroposterior relation established by the configuration system.

Exemplary embodiments of a work supporting system, a work supporting method, and a computer program product according to the present invention are described below in greater detail with reference to the accompanying drawings. A specific configuration should be determined based on the description below because the drawings schematically illustrate the embodiments.

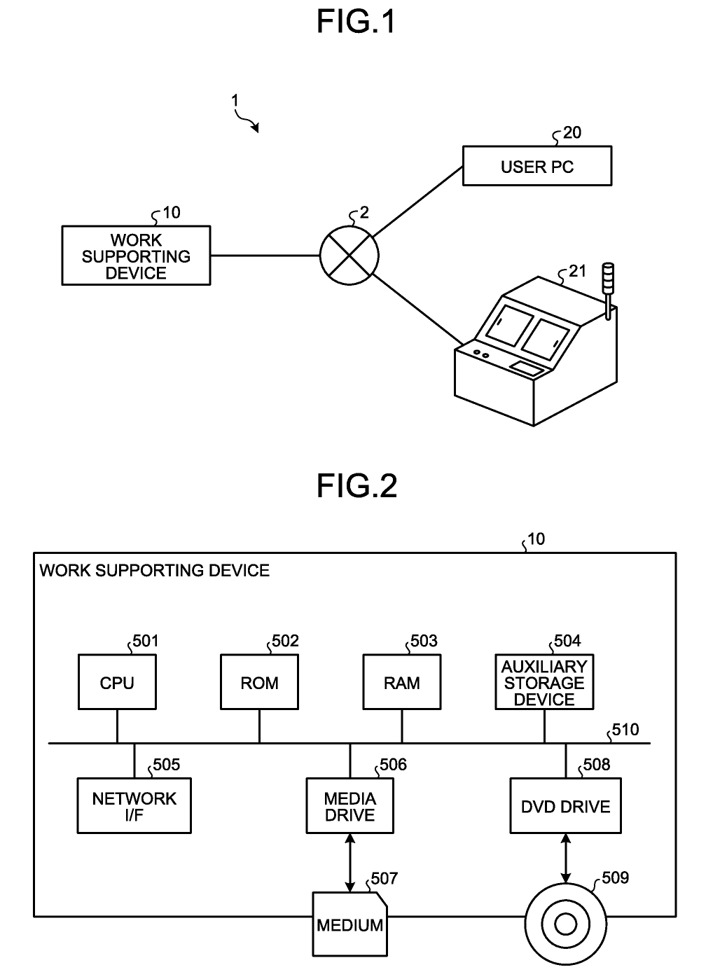

FIG. 1 is a diagram of an exemplary entire configuration of a work supporting system according to an embodiment. The following describes an exemplary entire configuration of a work supporting system 1 according to the present embodiment with reference to FIG. 1.

As illustrated in FIG. 1, the work supporting system 1 according to the present embodiment includes a work supporting device 10 and a user personal computer (PC) 20. Equipment 21 is connected to a network 2. The work supporting device 10, the user PC 20, and the equipment 21 can communicate with one another via the network 2.

The work supporting device 10 outputs work contents to be performed in maintenance and inspection from a maintenance log that records therein maintenance and inspection for equipment, machines, or apparatuses, for example. The work supporting device 10 is a server device, such as a PC and a workstation. The operation of outputting the work contents performed by the work supporting device 10 will be described later in detail.

The user PC 20 transmits, to the work supporting device 10 via the network 2, information (maintenance information) on records of actual work contents in maintenance and inspection (hereinafter, which may be simply referred to as “maintenance”) performed on equipment, machines, or apparatuses (hereinafter, which may be simply referred to as “equipment or the like”) input by an operator or other workers, for example. The user PC 20 is not limited to a PC and may be a workstation, for example. The number of user PCs 20 connected to the network 2 is not limited to one, and a plurality of user PCs 20 may be connected thereto.

The equipment 21 is an apparatus on which maintenance work is to be performed by the operator or other workers. The equipment 21 is not limited to an apparatus and may be other machines or devices, for example. The number of pieces of equipment 21 connected to the network 2 is not limited to one, and a plurality of pieces of equipment 21 may be connected thereto. While the equipment 21 is connected to the network 2 as illustrated in FIG. 1, the present invention is not limited thereto. The equipment 21 is not necessarily connected to the network 2.

The network 2 is a local area network (LAN), a dedicated line, the Internet, or the like that enables the work supporting device 10, the user PC 20, and the equipment 21 to communicate with one another. The network 2 may be a wired or wireless network.

While the user PC 20 and the equipment 21 that communicate with the work supporting device 10 share the network 2, the present invention is not limited thereto. The user PC 20 and the equipment 21 may communicate with the work supporting device 10 via respective networks.

In the configuration of the work supporting system 1 illustrated in FIG. 1, the user PC 20 has a function of receiving the maintenance information. However, the configuration for the function of receiving the maintenance information is not limited thereto. The work supporting device 10 itself may have a function of receiving the maintenance information. In this case, the work supporting system 1 is provided as the work supporting device 10.

FIG. 2 is a diagram of an exemplary hardware configuration of the work supporting device according to the embodiment. The following describes the hardware configuration of the work supporting device 10 according to the present embodiment with reference to FIG. 2.

As illustrated in FIG. 2, the work supporting device 10 according to the present embodiment includes a central processing unit (CPU) 501, a read only memory (ROM) 502, a random access memory (RAM) 503, an auxiliary storage device 504, a network I/F 505, a media drive 506, and a digital versatile disc (DVD) drive 508.

The CPU 501 is an arithmetic device that collectively controls the operations of the work supporting device 10. The ROM 502 is a non-volatile storage device that stores therein computer programs, such as a basic input/output system (BIOS) or other firmware, executed by the CPU 501 to control the functions. The RAM 503 is a volatile storage device used as a work area for the CPU 501.

The auxiliary storage device 504 is a non-volatile storage device that stores therein various data and computer programs, for example. The auxiliary storage device 504 is a hard disc drive (HDD) or a solid state drive (SSD), for example.

The network I/F 505 is an interface connected to an external network to communicate with an external device. The network I/F 505 is a communication device, such as a network interface card (NIC). Examples of the communication protocol of the network I/F 505 may include, but not limited to, transmission control protocol (TCP)/internet protocol (IP) and user datagram protocol (UDP)/IP.

The media drive 506 is a device that controls reading and writing of data from and to a medium 507, such as a flash memory, under the control of the CPU 501. The medium 507 is a storage device detachable from the media drive 506. The medium 507 is not limited to a flash memory as long as it is a non-volatile memory that performs reading and writing of data under the control of the CPU 501. The medium 507 may be an electrically erasable and programmable ROM (EEPROM), for example.

The DVD drive 508 is a device that controls reading and writing of data from and to a digital versatile disc read only memory (DVD-ROM) 509, which is an example of a detachable storage medium. Other examples of the detachable recording medium may include, but not limited to, a computer readable recording medium, such as a compact disc read only memory (CD-ROM), a compact disc recordable (CD-R), a digital versatile disc recordable (DVD-R), and a Blu-ray disc.

The CPU 501, the ROM 502, the RAM 503, the auxiliary storage device 504, the network I/F 505, the media drive 506, and the DVD drive 508 are connected via a bus 510, such as an address bus and a data bus, in a manner communicable with one another.

The configuration of the work supporting device 10 illustrated in FIG. 2 is given by way of example only. The work supporting device 10 does not necessarily include all the components described above or may include other components. The media drive 506, for example, is not necessarily provided if its functions can be performed by the DVD drive 508. In a case where an administrator or other workers performs operation input directly on the work supporting device 10, the work supporting device 10 may include an operating device, such as a mouse and a keyboard, and a display device (display) that displays results of input through the operating device.

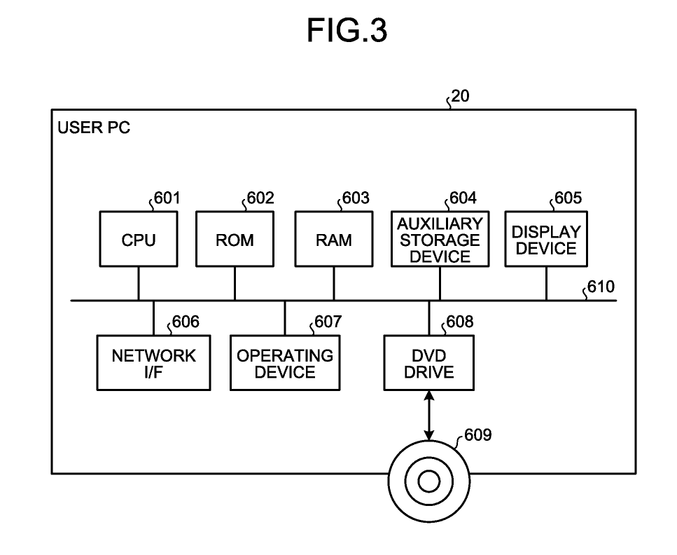

FIG. 3 is a diagram of an exemplary hardware configuration of the user PC according to the embodiment. The following describes the hardware configuration of the user PC 20 according to the present embodiment with reference to FIG. 3.

As illustrated in FIG. 3, the user PC 20 according to the present embodiment includes a CPU 601, a ROM 602, a RAM 603, an auxiliary storage device 604, a display device 605, a network I/F 606, an operating device 607, and a DVD drive 608.

The CPU 601 is an arithmetic device that collectively controls the operations of the user PC 20. The ROM 602 is a non-volatile storage device that stores therein computer programs, such as a BIOS or other firmware, executed by the CPU 601 to control the functions. The RAM 603 is a volatile storage device used as a work area for the CPU 601.

The auxiliary storage device 604 is a non-volatile storage device that stores therein various data and computer programs, for example. The auxiliary storage device 604 is an HDD or an SSD, for example.

The display device 605 displays a screen of an application executed by the CPU 601, for example. The display device 605 is a cathode ray tube (CRT) display, a liquid crystal display, or an organic electroluminescence (EL) display, for example.

The network I/F 606 is an interface connected to an external network to communicate with an external device. The network I/F 606 is a communication device, such as a NIC. Examples of the communication protocol of the network I/F 606 may include, but not limited to, TCP/IP and UDP/IP.

The operating device 607 is a device with which a user performs operation input to cause the CPU 601 to perform predetermined processing. Examples of the operation input may include, but not limited to, input of characters and numerals, input of an operation of selecting various instructions, input of an operation of moving a cursor. The operating device 607 is an input device, such as a mouse, a keyboard, a numeric keypad, a touch pad, and a touch panel.

The DVD drive 608 is a device that controls an operation of reading or writing data from or to a DVD-ROM 609 serving as a detachable storage medium, for example. Other examples of the detachable recording medium may include, but not limited to, a computer readable or writable recording medium, such as a CD-ROM, a CD-R, a DVD-R, and a Blu-ray disc.

The CPU 601, the ROM 602, the RAM 603, the auxiliary storage device 604, the display device 605, the network I/F 606, the operating device 607, and the DVD drive 608 are connected via a bus 610, such as an address bus and a data bus, in a manner communicable with one another. The configuration of the user PC 20 illustrated in FIG. 3 is given by way of example only. The user PC 20 does not necessarily include all the components described above or may include other components. The user PC 20 may include a media drive that controls reading and writing of data from and to a flash memory, for example, besides the DVD drive 608.

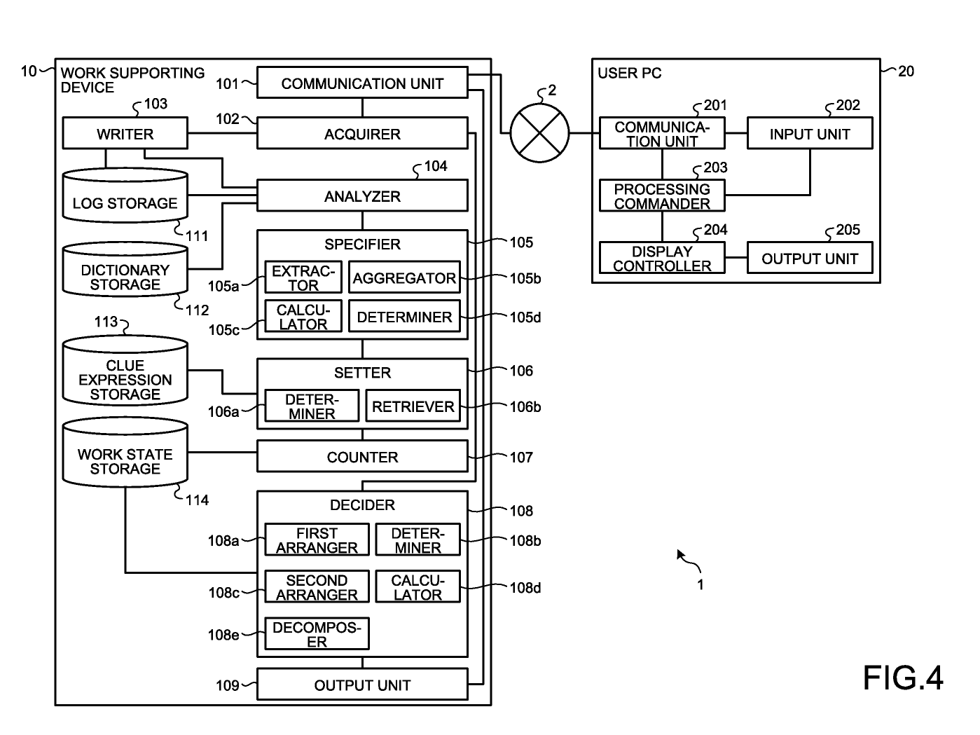

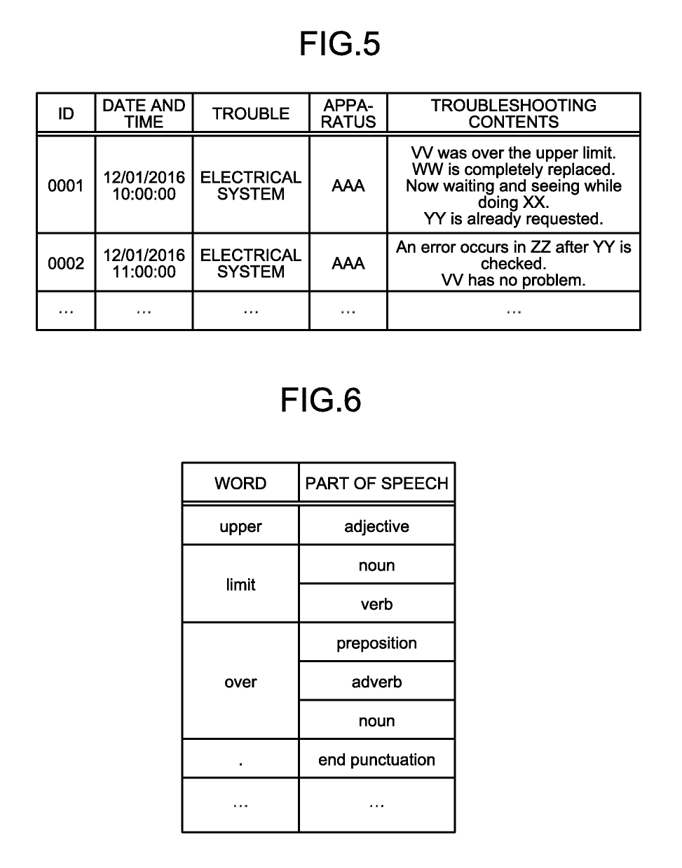

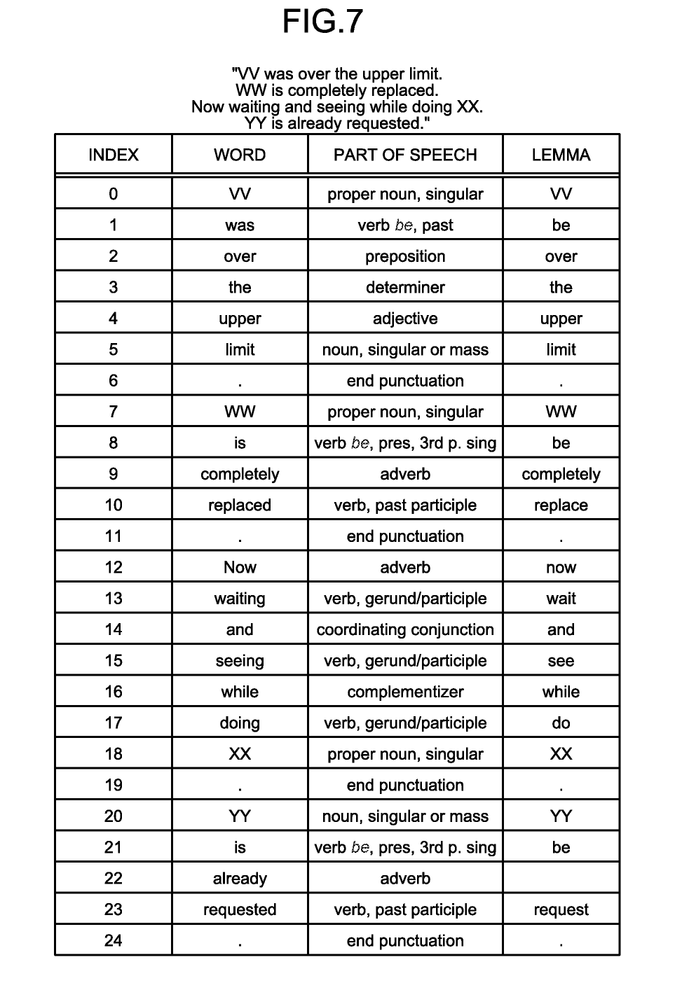

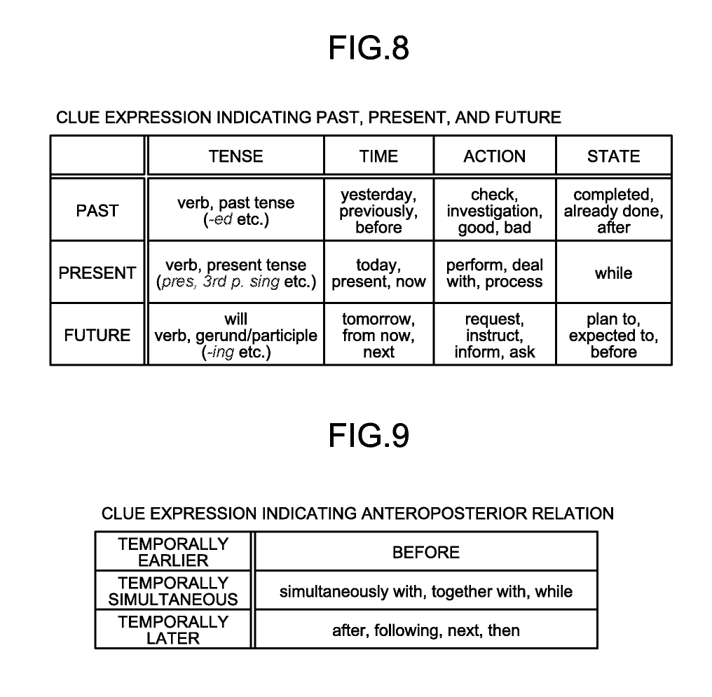

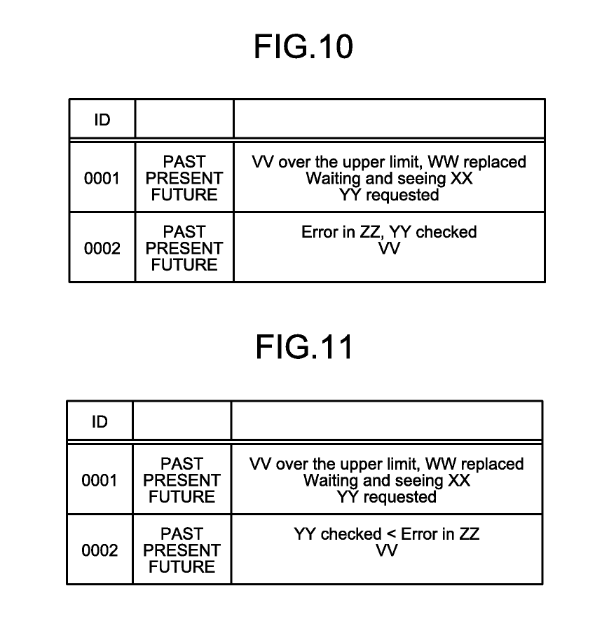

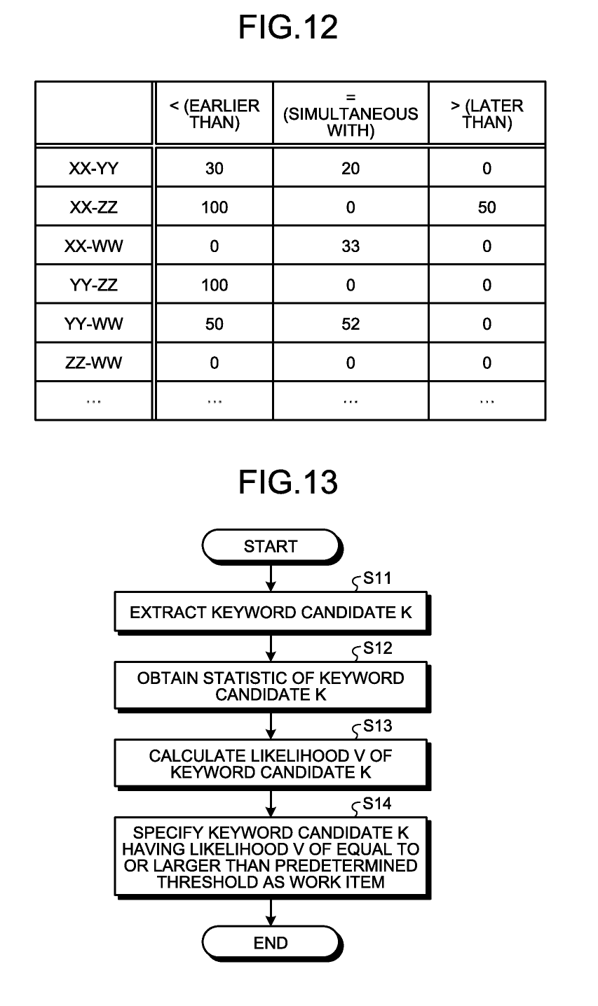

FIG. 4 is a diagram of an exemplary configuration of functional blocks in the work supporting system according to the embodiment. FIG. 5 illustrates an example of a maintenance log. FIG. 6 illustrates an example of a language analysis dictionary. FIG. 7 is illustrates example of a result of natural language processing. FIG. 8 illustrates an example of clue expressions indicating the past, the present, and the future. FIG. 9 illustrates an example of clue expressions indicating an anteroposterior relation. FIG. 10 illustrates an example of results of setting specified work items to the past, the present, and the future. FIG. 11 illustrates an example of results of setting a temporal anteroposterior relation to the specified work items. FIG. 12 illustrates an example of a work state database. The following describes the configuration and the operations of the functional blocks in the work supporting system 1 according to the present embodiment with reference to FIGS. 4 to 12.

As illustrated in FIG. 4, the work supporting device 10 of the work supporting system 1 according to the present embodiment includes a communication unit 101, an acquirer 102, a writer 103, an analyzer 104, a specifier 105, a setter 106, a counter 107, a decider 108, an output unit 109, a log storage 111, a dictionary storage 112, a clue expression storage 113, and a work state storage 114.

The communication unit 101 is a functional unit that performs data communications with an external device, such as the user PC 20, via the network 2. The communication unit 101 is provided by the network I/F 505 illustrated in FIG. 2.

The acquirer 102 is a functional unit that acquires, via the network 2 and the communication unit 101, maintenance information and a command to output the work contents received by the user PC 20, for example.

The writer 103 is a functional unit that writes the maintenance information acquired by the acquirer 102 to a maintenance log in the log storage 111. FIG. 5 illustrates an example of the maintenance log recorded in the log storage 111. The example of the maintenance log illustrated in FIG. 5 is information in which “ID”, “date and time”, “trouble”, “apparatus”, and “troubleshooting” are associated with one another. “ID” uniquely identifies a piece of maintenance information. “Date and time” indicates the date and time when maintenance is performed. “Trouble” indicates the position or the system having a trouble in equipment or the like on which the maintenance is to be performed. “Apparatus” indicates the information for identifying the equipment or the like on which the maintenance is to be performed. “Troubleshooting” indicates the work contents in the actual maintenance. The maintenance information having the ID “0002”, for example, indicates that the date and time is “Dec. 1, 2016 11:00:00”, the trouble is “electrical system”, the apparatus is “AAA”, and the troubleshooting contents are “an error in ZZ occurs after YY is checked. VV has no problem.”

The maintenance log is not limited to information in a tabular form illustrated in FIG. 5. The maintenance log may be information in any desired form as long as it has the items associated with one another as described above. In the description below, the maintenance log is assumed to be the information in a tabular form illustrated in FIG. 5. Information (maintenance information) in a “row” in the tabular form may be referred to as a “record”.

The analyzer 104 is a functional unit that reads each record in the maintenance log stored in the log storage 111 and performs natural language processing on text (e.g., information in “troubleshooting”) included in the record using a language analysis dictionary stored in the dictionary storage 112.

FIG. 6 illustrates an example of the language analysis dictionary. The example of the language analysis dictionary illustrated in FIG. 6 is information in which “word” and “part of speech” are associated with one another. “Word” indicates a word in text. “Part of speech” indicates the part of speech of the word. The language analysis dictionary is not limited to information in a tabular form illustrated in FIG. 6. The language analysis dictionary may be information in any desired form as long as it has the items associated with one another as described above.

FIG. 7 illustrates an example of a result of the natural language processing performed by the analyzer 104. The example illustrated in FIG. 7 indicates a result of the natural language processing performed on the text of the troubleshooting, “VV was over the upper limit. WW is completely replaced. Now waiting and seeing while doing XX. YY is already requested.” corresponding to ID “0001” in the maintenance log illustrated in FIG. 5. The example of a result of the natural language processing illustrated in FIG. 7 is information in which “index” that uniquely indicates an analyzed word, “word” of the word, “part of speech” of the word, and “lemma” of the word are associated with one another.

The text subjected to the natural language processing by the analyzer 104 is expressed by a natural sentence or the like input through the user PC 20 by the operator or other workers who performs the maintenance. The natural sentence is a written language or a spoken language usually used by people. The text subjected to the natural language processing is not necessarily a natural sentence or a definite sentence. Text indicating a numerical formula, such as “KK>30”, can be subjected to the natural language processing if it has the meaning that “KK is larger than 30”, for example. The text received by the user PC 20 may include orthographic variations depending on the operator.

The text subjected to the natural language processing is not limited to text input by the operator or other workers through the user PC 20. Let us assume a case where the equipment 21 can automatically output, when the value of a sensor in the equipment 21 or an arithmetic result of the arithmetic device indicates abnormality, text indicating the contents of abnormality, for example. In this case, the text received via the network 2 may also be subjected to the natural language processing (information indicated by the text is also referred to as the “maintenance information” in a broad sense). Also in this case, the received text may include orthographic variations depending on the specifications of the equipment 21 or whether the text is output from different pieces of equipment 21. The text subjected to the natural language processing according to the present embodiment is written in English, but not limited thereto. The text may be written in foreign languages, such as Japanese, as long as it can be subjected to the natural language processing.

The natural language processing is performed by the analyzer 104 at the timing when the writer 103 writes the maintenance information as a new record in the maintenance log in the log storage 111, for example.

The specifier 105 is a functional unit that extracts keyword candidates using a predetermined method from the text subjected to the natural language processing by the analyzer 104 and specifies work items from the extracted keyword candidates. As illustrated in FIG. 4, the specifier 105 includes an extractor 105a, an aggregator 105b, a calculator 105c, and a determiner 105d.

The extractor 105a is a functional unit that extracts word strings corresponding to a specific pattern as the keyword candidates from the text subjected to the natural language processing by the analyzer 104. If the specific pattern includes a nominal group, for example, the extractor 105a extracts noun phases, such as “VV” and “the upper limit” from the text subjected to the natural language processing as the keyword candidates.

The extraction of the keyword candidates by the extractor 105a may be performed by machine learning using seed keywords, for example.

The aggregator 105b is a functional unit that aggregates the keyword candidates extracted by the extractor 105a. The aggregator 105b, for example, obtains the frequency of each keyword candidate as a statistic or obtains the number of long collocations each including a keyword candidate to calculate a C-value common in the language processing field.

The calculator 105c is a functional unit that calculates a C-value corresponding to each keyword candidate from the corresponding statistic obtained by the aggregator 105b and calculates the likelihood of the keyword candidate using the calculated C-value. If the frequency of a keyword candidate or the C-value corresponding to the keyword candidate is equal to or smaller than a predetermined threshold when the calculator 105c calculates the likelihood of the keyword candidates, the keyword candidate may be excluded from the target of calculation of the likelihood.

The determiner 105d is a functional unit that determines whether the likelihood of the keyword candidates calculated by the calculator 105c is equal to or larger than a predetermined threshold. The specifier 105 specifies the keyword candidates determined to have the likelihood of equal to or larger than the predetermined threshold by the determiner 105d as the final work items. The work item specification performed by the specifier 105 will be described later with reference to FIG. 13.

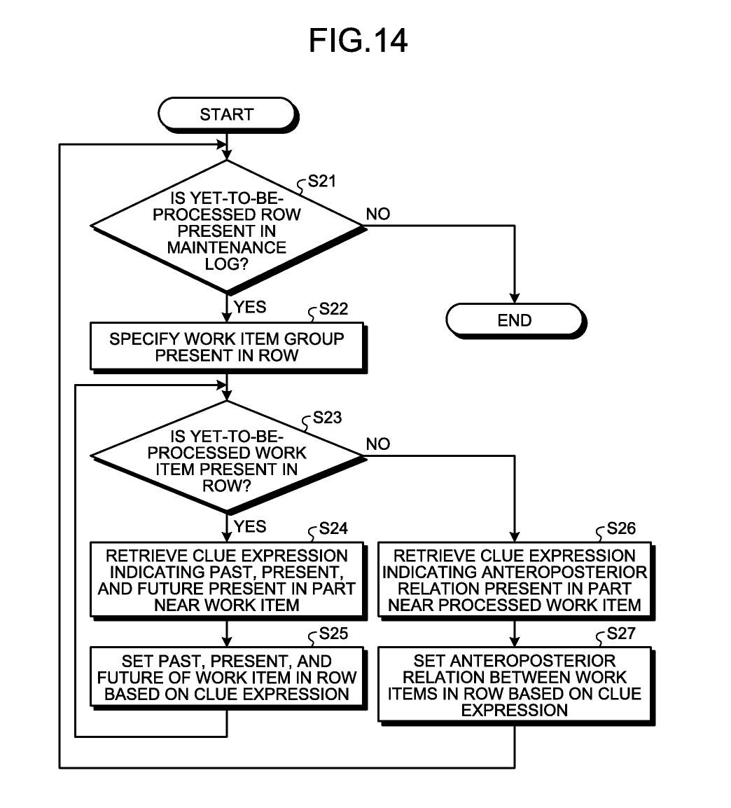

The setter 106 is a functional unit that determines whether the text included in the record in the maintenance log includes the work items specified by the specifier 105. If the work items are included, the setter 106 determines whether a part near the work items in the text includes prescribed clue expressions, thereby setting the past, the present, and the future of the work items and the temporal anteroposterior relation between the work items. The past, the present, and the future are determined with reference to “date and time” in the record in the maintenance log including the work items. As illustrated in FIG. 4, the setter 106 includes a determiner 106a and a retriever 106b. The anteroposterior relation setting performed by the setter 106 will be described later with reference to FIG. 14.

The determiner 106a is a functional unit that determines whether a work item yet to be subjected to the anteroposterior relation setting by the setter 106 is present among the work items specified in the work item specification performed by the specifier 105 in the maintenance log.

The retriever 106b is a functional unit that determines whether a part near a target work item included in the text in the record includes clue expressions indicating the past, the present, and the future and clue expressions indicating the temporal anteroposterior relation between the work items stored in the clue expression storage 113. The part near the work item corresponding to the range in which the clue expressions are retrieved is a range of a predetermined number of characters or a predetermined number of words before and after the target work item in the text of the troubleshooting in the target record in the maintenance log, for example. In this case, if the range is defined strictly by the predetermined number of characters or the predetermined number of words before and after the target work item, the retrieving may possibly be performed on another sentence adjacent thereto. To address this, if a period or a line-feed code indicating a break of a sentence or the start or the end of the text of the troubleshooting is detected in the predetermined number of characters or the predetermined number of words, for example, the retrieving is terminated. Alternatively, the range may reach up to a work item prior to the target work item, for example. In this case, if a period or a line-feed code indicating a break of a sentence or the start of the text of the troubleshooting is detected before the prior work item, for example, the retrieving is terminated. Still alternatively, the range may reach up to a work item posterior to the target work item, for example. In this case, if a period or a line-feed code indicating a break of a sentence or the end of the text of the troubleshooting is detected before the posterior work item, for example, the retrieving is terminated.

FIG. 8 illustrates an example of the clue expressions indicating the past, the present, and the future. The example of the clue expressions indicating the past, the present, and the future illustrated in FIG. 8 includes expressions of “tense”, expressions of “time”, expressions of “action”, and expressions of “state” indicating the past, the present, and the future, respectively. Examples of the expressions of “tense” indicating the past include, but not limited to, “verb, past tense”. Examples of the expressions of “time” indicating the past include, but not limited to, “yesterday”, “previously”, and “before”. Examples of the expressions of “action” indicating the past include, but not limited to, “check”, “investigation”, “good”, and “bad”. Examples of the expressions of “state” indicating the past include, but not limited to, “completed”, “already done”, and “after”.

FIG. 9 illustrates an example of the clue expressions indicating the temporal anteroposterior relation between the work items. The example of the clue expressions indicating the temporal anteroposterior relation between the work items illustrated in FIG. 9 includes expressions of “temporally earlier”, expressions of “temporally simultaneous”, and expressions of “temporally later”. Examples of the expressions of “temporally simultaneous” include, but are not limited to, “simultaneously with”, “together with”, and “while”.

FIG. 10 illustrates an example of results of retrieving the clue expressions indicating the past, the present, and the future by the retriever 106b and setting the specified work items to the past, the present, and the future by the setter 106. The example illustrated in FIG. 10 indicates results of setting the past, the present, and the future to the work items specified by the specifier 105 from the text of the troubleshooting in the maintenance log illustrated in FIG. 5. FIG. 10 indicates that “VV over the upper limit” and “WW replaced” are set to the past, “Waiting and seeing XX” is set to the present, and “YY requested” is set to the future out of the work items specified by the specifier 105 in the text of the troubleshooting contents having ID “0001” in the maintenance log, for example.

FIG. 11 illustrates an example of results of searching for the clue expressions indicating the temporal anteroposterior relation between the work items by the retriever 106b and setting the temporal anteroposterior relation between the work items to the work items to which the past, the present, and the future are set by the setter 106. The example illustrated in FIG. 11 indicates results of setting the temporal anteroposterior relation between the work items to the work items to which the past, the present, and the future are set by the setter 106 as illustrated in FIG. 10. FIG. 11 indicates that “error in ZZ” occurs after “YY checked” as the temporal anteroposterior relation between “error in ZZ” and “YY checked”, both of which are set to the past, out of the work items to which the past, the present, and the future are set by the setter 106 in the text of the troubleshooting having ID “0002” in the maintenance log, for example. This is based on the fact that the clue expression “after” indicating “temporally later” is retrieved between the work items “error in ZZ” and “YY checked” by the retriever 106b in the text of the troubleshooting having ID “0002” in the maintenance log.

If the retriever 106b retrieves no clue expression indicating the past, the present, and the future, the setter 106 may allocate the work item to the present or ignore the work item because the time period to which it belongs is unknown, for example. If the retriever 106b retrieves no clue expression indicating the temporal anteroposterior relation, the setter 106 may allocate the work items to “temporally simultaneous” or consider that the temporal anteroposterior relation therebetween is unknown, for example.

If two or more clue expressions contradictory to each other are retrieved for one work item, the setter 106 specifies one clue expression by determining the degree of priority of the clue expressions in advance or selecting the clue expression retrieved more frequently, for example. Alternatively, the relation between the work items may be counted by the counter 107, which will be described later, while remaining in the contradictory state (e.g., the state where two or more of the past, the present, and the future can be applied to the work item or the state where two or more anteroposterior relations are defined) without specifying one clue expression.

The counter 107 is a functional unit that counts the temporal anteroposterior relation (“temporally earlier”, “temporally simultaneous”, and “temporally later”) between the work items set by the setter 106 for each pair of the work items. Specifically, every time the setter 106 sets the past, the present, and the future and the temporal anteroposterior relation to the work items specified by the specifier 105, the counter 107 counts the temporal anteroposterior relation between the set two work items.

FIG. 12 illustrates an example of a work state database that stores therein the number of counts (frequency) of the temporal anteroposterior relation between the set work items. The work state database is stored in the work state storage 114 illustrated in FIG. 4. As indicated by the work state database in FIG. 12, every time the temporal anteroposterior relation is set between two work items set by the setter 106, the counter 107 counts the number of temporal anteroposterior relations set between the two work items. The work items are simply represented like “WW” to “ZZ” in FIG. 12. In the anteroposterior relation between the work item “YY” and the work item “ZZ” in the example illustrated in FIG. 12, the number of counts of the anteroposterior relation of “temporally earlier” (“<”) is 100. The number of counts of the other anteroposterior relations (“temporally simultaneous” (“=”) and “temporally later” (“>”)) is 0. In this case, the anteroposterior relation between the work item “YY” and the work item “ZZ” is uniquely determined to be “YY<ZZ” (ZZ comes after YY). By contrast, in the anteroposterior relation between the work item “XX” and the work item “YY”, the number of counts of the anteroposterior relation of “temporally earlier” is 30, and the number of counts of the anteroposterior relation of “temporally simultaneous” is 20. In this case, the anteroposterior relation between the work item “XX” and the work item “YY” fails to be uniquely determined. To address this, the decider 108, which will be described later, determines the final anteroposterior relation.

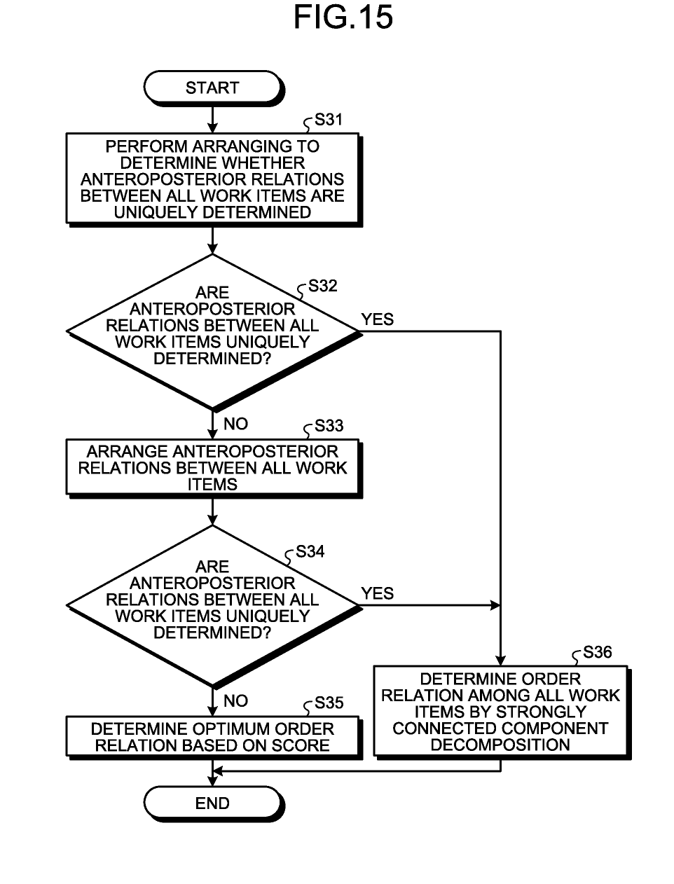

The decider 108 is a functional unit that finally determines the order relation among all the work items based on the number of counts (frequency) of the temporal anteroposterior relation between each pair of the work items counted by the counter 107 when the acquirer 102 acquires a command to output the work contents from the user PC 20. Specifically, the decider 108 refers to the work state database in the work state storage 114 to determine the order relation among all the work items based on the number of counts (frequency) of the anteroposterior relation between each pair of the work items. As illustrated in FIG. 4, the decider 108 includes a first arranger 108a, a determiner 108b, a second arranger 108c, a calculator 108d, and a decomposer 108e. The order relation determination performed by the decider 108 will be described later with reference to FIG. 15.

The first arranger 108a is a storage that refers to the work state database in the work state storage 114 and performs organizing to determine whether the anteroposterior relations between all the work items are uniquely determined based on the number of counts (frequency) of the temporal anteroposterior relation between the work items.

The determiner 108b is a functional unit that determines whether the anteroposterior relations between all the work items are uniquely determined based on the results of organizing performed by the first arranger 108a and the second arranger 108c.

The second arranger 108c is a functional unit that organizes, if certain work items out of all the work items have two or more anteroposterior relations, the two or more anteroposterior relations into one anteroposterior relation using a predetermined method. Examples of the predetermined method may include, but not limited to: a method of selecting the anteroposterior relation most frequently detected; a method of eliminating the anteroposterior relation having a frequency smaller than a predetermined threshold; a method of eliminating the anteroposterior relation having variation (dispersion) of the frequency larger than a predetermined threshold or considering the two work items to be “temporally simultaneous” because the fact that the work items have two or more anteroposterior relations means that they can be performed in any desired order with no problem. Let us assume a case where a method of eliminating the anteroposterior relation having a frequency smaller than the predetermined threshold (“10” in this example) is employed as the predetermined method, for example. In the anteroposterior relations between the work item “XX” and the work item “YY” illustrated in FIG. 12, neither “temporally earlier” nor “temporally simultaneous” are eliminated because the number of counts “30” of “temporally earlier” and the number of counts “20” of “temporally simultaneous” are both larger than the predetermined threshold. As described above, the two or more anteroposterior relations may possibly fail to be organized into one.

The calculator 108d is a functional unit that generates permutations of all the work items and calculates the total of the frequencies relating to the anteroposterior relations between the work items for each permutation as a score if the determiner 108b determines that the anteroposterior relations between all the work items are not uniquely determined based on the results of arranging performed by the second arranger 108c. The calculator 108d determines the permutations of the work items having the optimum calculated score to be the final order relation among all the work items. The calculator 108d, for example, may calculate the total of the frequencies of the anteroposterior relations on the work state database corresponding to the anteroposterior relations between the work items in each permutation as a score corresponding to the permutation, thereby determining the permutations having the largest calculated score to be the final order relation among all the work items. Alternatively, the calculator 108d may calculate the total of the frequencies of the anteroposterior relations on the work state database not corresponding to the anteroposterior relations between the work items in each permutation as a score corresponding to the permutation, thereby determining the permutations having the smallest calculated score to be the final order relation among all the work items.

All the methods using the score can calculate the optimum order relation among all the work items. The calculator 108d, however, may possibly fail to finish the calculation in practical time because of combinational explosion associated with increase in the number of work items, for example. To address this, the calculator 108d preferably calculates the score after eliminating as many work items as possible by removing the work items having a clear anteroposterior relation based on the results of arranging of the anteroposterior relations performed by the first arranger 108a and the determiner 108b, for example.

The decomposer 108e is a functional unit that performs strongly connected component decomposition on each work item, thereby determining the final order relation among all the work items if the anteroposterior relations between all the work items are uniquely determined based on the results of arranging performed by the first arranger 108a or the second arranger 108c. Specifically, the decomposer 108e defines each work item as a node. The decomposer 108e integrates two work items (nodes) having only the anteroposterior relation of “temporally simultaneous” (“=”) into one node. The decomposer 108e connects two work items (nodes) having only the anteroposterior relation of “temporally earlier” (“<”) or “temporally later” (“>”) with a directional branch so as to indicate the order. The decomposer 108e thus obtains a directed graph connected with directional branches. The decomposer 108e performs strongly connected component decomposition on the directed graph, thereby decomposing the graph into strongly connected components. As a result, the work items serving as the nodes included in the strongly connected components resulting from decomposition correspond to the work items that can be simultaneously performed. The direction of the directional branch connecting the strongly connected components indicates the work order of the group of work items serving as the nodes included in each strongly connected component.

Let us assume a case where three work items “LL”, “MM”, and “NN” are arranged to have anteroposterior relations of “LL<MM” (LL is performed before MM), “MM<NN” (MM is performed before NN), and “NN<LL” (NN is performed before LL) as a result of arranging performed by the first arranger 108a or the second arranger 108c, for example. In this case, the three work items are repeatedly performed. The directed graph of the work items “LL”, “MM”, and “NN” is formed into a closed loop, and the three work items are decomposed into the same strongly connected component in the strongly connected component decomposition. In this case, the decomposer 108e may consider the three work items as the work items that can be simultaneously performed or the work items that can be performed in any desired order because they are included in the same strongly connected component, for example.

The output unit 109 is a functional unit that outputs the order relation among all the work items decided by the decider 108. The output unit 109 outputs the order relation among all the work items in a form of a check sheet, a sequence diagram, or a flowchart, for example. The output unit 109 transmits the information indicating the order relation among all the work items, such as the check sheet, the sequence diagram, and the flowchart, to the user PC 20 via the communication unit 101 and the network 2.

The acquirer 102, the writer 103, the analyzer 104, the specifier 105, the setter 106, the counter 107, the decider 108, and the output unit 109 are provided by the CPU 501 illustrated in FIG. 2 executing the computer programs serving as software. Part or all of the acquirer 102, the writer 103, the analyzer 104, the specifier 105, the setter 106, the counter 107, the decider 108, and the output unit 109 may be provided not by execution of the computer programs but by a hardware circuit, such as a field-programmable gate array (FPGA) and an application specific integrated circuit (ASIC).

The log storage 111 is a functional unit that stores therein the maintenance log. The dictionary storage 112 is a functional unit that stores therein the language analysis dictionary used for the natural language processing. The clue expression storage 113 is a functional unit that stores therein the clue expressions indicating the past, the present, and the future and the clue expressions indicating the temporal anteroposterior relation. The work state storage 114 is a functional unit that stores therein the work state database. The log storage 111, the dictionary storage 112, the clue expression storage 113, and the work state storage 114 are provided by the auxiliary storage device 504 illustrated in FIG. 2. The log storage 111, the dictionary storage 112, the clue expression storage 113, and the work state storage 114, which are provided by the auxiliary storage device 504 in the work supporting device 10 as described above, may be provided by an external storage device outside the work supporting device 10. The log storage 111, the dictionary storage 112, the clue expression storage 113, and the work state storage 114 are not necessarily provided by the auxiliary storage device 504 serving as a single storage device, and part or all of them may be provided by respective storage devices.

The communication unit 101, the acquirer 102, the writer 103, the analyzer 104, the specifier 105, the setter 106, the counter 107, the decider 108, the output unit 109, the log storage 111, the dictionary storage 112, and the clue expression storage 113 of the work supporting device 10 illustrated in FIG. 4 conceptually represent the functions, and the work supporting device 10 does not necessarily have the configuration described above. A plurality of functional units provided as independent functional units in the work supporting device 10 illustrated in FIG. 4 may be provided as one functional unit, for example. By contrast, one functional unit in the work supporting device 10 illustrated in FIG. 4 may be provided as a plurality of functional units by dividing the function of the functional unit into a plurality of functions.

As illustrated in FIG. 4, the user PC 20 of the work supporting system 1 according to the present embodiment includes a communication unit 201, an input unit 202, a processing commander 203, a display controller 204, and an output unit 205.

The communication unit 201 is a functional unit that performs data communications with an external device, such as the work supporting device 10, via the network 2. The communication unit 201 is provided by the network I/F 606 illustrated in FIG. 3.

The input unit 202 is a functional unit that receives operation input from the user (operator or other workers). The input unit 202 is provided by the operating device 607 illustrated in FIG. 3.

The processing commander 203 is a functional unit that transmits a command to output the work contents to the work supporting device 10 via the communication unit 201 and the network 2 in response to the operation input received from the user (operator or other workers) through the input unit 202. The processing commander 203 receives information on the work contents (specifically, information on the order relation among all the work items) from the work supporting device 10 via the network 2 and the communication unit 201. The processing commander 203 is provided by the CPU 601 illustrated in FIG. 3 executing the computer programs serving as software.

The display controller 204 is a functional unit that controls an output operation (display operation) of the output unit 205. The display controller 204 is provided by the CPU 601 illustrated in FIG. 3 executing the computer programs serving as software.

The output unit 205 is a functional unit that outputs (displays) the information on the work contents received by the processing commander 203 under the control of the display controller 204. The output unit 205 is provided by the display device 605 illustrated in FIG. 3, for example. The output unit 205 is not necessarily provided by the display device 605 and may output the information on the work contents by another output system, such as a printing device. In this case, the display controller 204 is provided by the CPU 601 executing a printer driver.

Part or all of the processing commander 203 and the display controller 204 may be provided not by execution of the computer programs but by a hardware circuit, such as an FPGA and an ASIC.

The communication unit 201, the input unit 202, the processing commander 203, the display controller 204, and the output unit 205 of the user PC 20 illustrated in FIG. 4 conceptually represent the functions, and the user PC 20 does not necessarily have the configuration described above. A plurality of functional units provided as independent functional units in the user PC 20 illustrated in FIG. 4 may be provided as one functional unit, for example. By contrast, one functional unit in the user PC 20 illustrated in FIG. 4 may be provided as a plurality of functional units by dividing the function of the functional unit into a plurality of functions.

FIG. 13 is a flowchart of an example of the work item specification performed by the work supporting device according to the embodiment. The following describes the procedure of the work item specification performed by the work supporting device 10 according to the present embodiment with reference to FIG. 13.

Step S11

The extractor 105a of the specifier 105 extracts a word string that is matched with a specific pattern as a keyword candidate K from text subjected to a natural language processing by the analyzer 104. The process then proceeds to Step S12.

Step S12

The aggregator 105b of the specifier 105 obtains the statistic of each keyword candidate K extracted by the extractor 105a. The aggregator 105b, for example, the frequency of each keyword candidate K as the statistic or the number of long collocations each including the keyword candidate K to calculate a C-value common in the language processing field. The process then proceeds to Step S13.

Step S13

The calculator 105c of the specifier 105 calculates the C-value for the keyword candidate K from the corresponding statistic obtained by the aggregator 105b and calculates a likelihood V of the keyword candidate K using the calculated C-value. The process then proceeds to Step S14.

Step S14

The determiner 105d of the specifier 105 determines whether the likelihood V of the keyword candidate K calculated by the calculator 105c is equal to or larger than a predetermined threshold. The specifier 105 specifies the keyword candidate K determined to have the likelihood V of equal to or larger than the predetermined threshold by the determiner 105d as the final work item. The work item specification is then finished.

By performing the processing from Step S11 to Step S14, the work supporting device 10 performs the work item specification.

FIG. 14 is a flowchart of an example of the anteroposterior relation setting performed by the work supporting device according to the embodiment. The following describes the procedure of the anteroposterior relation setting performed by the work supporting device 10 according to the present embodiment with reference to FIG. 14.

Step S21

The determiner 106a of the setter 106 determines whether a record (row) yet to be subjected to the anteroposterior relation setting by the setter 106 is present among the work items specified in the work item specification performed by the specifier 105 in the maintenance log stored in the log storage 111. If a record yet to be subjected to the anteroposterior relation setting is present (Yes at Step S21), the process proceeds to Step S22. If not (No at Step S21), the anteroposterior relation setting is finished.

Step S22

The setter 106 specifies a work item group (group of work items specified by the specifier 105) present in the record (row) (target record) yet to be subjected to the anteroposterior relation setting. The process then proceeds to Step S23.

Step S23 The determiner 106a determines whether a work item (yet-to-be-processed work item) yet to be subjected to setting of the past, the present, and the future in the anteroposterior relation setting is present in the target record (row). If a work item (yet-to-be-processed work item) yet to be subjected to the setting is present (Yes at Step S23), the process proceeds to Step S24. If not (No at Step S23), the process proceeds to Step S26.

Step S24

The retriever 106b of the setter 106 determines whether a part near the yet-to-be-processed work item in the text in the target record includes a clue expression indicating the past, the present, and the future stored in the clue expression storage 113. The part near the work item corresponding to the range in which the clue expression is searched for is as described above. The process then proceeds to Step S25.

Step S25

The setter 106 sets the past, the present, and the future to the yet-to-be-processed work item based on the clue expression indicating the past, the present, and the future retrieved by the retriever 106b. The process is then returned to Step S23.

Step S26

The retriever 106b determines whether a part near the work item (processed work item) subjected to the setting of the past, the present, and the future in the text in the target record includes a clue expression indicating the temporal anteroposterior relation between the work items stored in the clue expression storage 113. The part near the work item corresponding to the range in which the clue expression is retrieved is as described above. The process then proceeds to Step S27.

Step S27

The setter 106 sets the temporal anteroposterior relation to the processed work item based on the clue expression indicating the temporal anteroposterior relation between the work items retrieved by the retriever 106b. The process is then returned to Step S21.

By performing the processing from Step S21 to Step S27, the work supporting device 10 performs the anteroposterior relation setting.

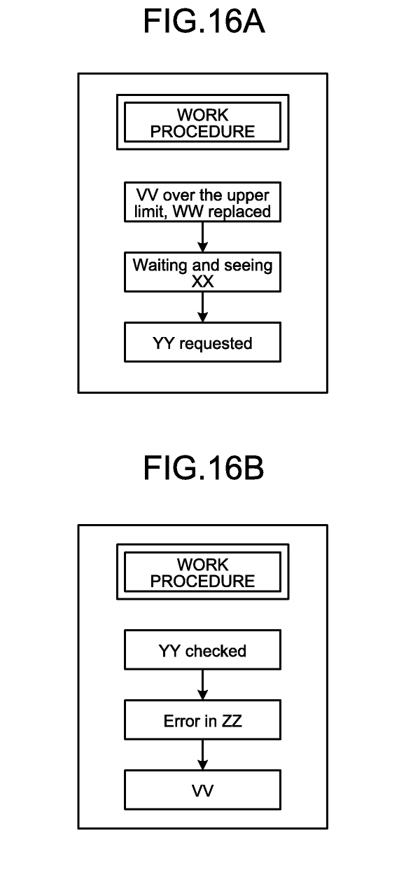

FIG. 15 is a flowchart of an example of the order relation determination performed by the work supporting device according to the embodiment. FIGS. 16A and 16B illustrate output examples of the determined order relation among the work items. The following describes the procedure of the order relation determination performed by the work supporting device 10 according to the present embodiment with reference to FIGS. 15, 16A, and 16B. The counter 107 has already performed, before the order relation determination illustrated in FIG. 15, the operation of counting the anteroposterior relation between the work items on the maintenance log sufficiently for the order relation determination.

Step S31

The first arranger 108a of the decider 108 refers to the work state database in the work state storage 114 and perform arranging to determine whether the anteroposterior relations between all the work items are uniquely determined based on the number of counts (frequency) of the temporal anteroposterior relation between the work items. The process then proceeds to Step S32.

Step S32

The determiner 108b of the decider 108 decides whether the anteroposterior relations between all the work items are uniquely determined based on the results of arranging performed by the first arranger 108a. If not (No at Step S32), the process proceeds to Step S33. If the anteroposterior relations are uniquely determined (Yes at Step S32), the process proceeds to Step S36.

Step S33

If certain work items out of all the work items have two or more anteroposterior relations, the second arranger 108c of the decider 108 arranges the two or more anteroposterior relations into one anteroposterior relation using a predetermined method. Even if the second arranger 108c tries to arrange the two or more anteroposterior relations into one using the predetermined method, the second arranger 108c may possibly fail to arrange them into one as described above. The process then proceeds to Step S34.

Step S34

The determiner 108b determines whether the anteroposterior relations between all the work items are uniquely determined based on the results of arranging performed by the second arranger 108c. If not (No at Step S34), the process proceeds to Step S35. If the anteroposterior relations are uniquely determined (Yes at Step S34), the process proceeds to Step S36.

Step S35

If the determiner 108b determines that the anteroposterior relations between all the work items are not uniquely determined based on the results of arranging performed by the second arranger 108c, the calculator 108d of the decider 108 generates permutations of all the work items and calculates the total of the frequencies relating to the anteroposterior relations between the work items for each permutation as a score. The calculator 108d determines the permutations of the work items having the optimum calculated score to be the final order relation among all the work items. The output unit 109 outputs the order relation among all the work items decided by the decider 108 (calculator 108d) in a form of a check sheet, a sequence diagram, or a flowchart, for example. The order relation determination is then finished.

Step S36

If the anteroposterior relations between all the work items are uniquely determined based on the results of arranging performed by the first arranger 108a or the second arranger 108c, the decomposer 108e of the decider 108 performs the strongly connected component decomposition on each work item, thereby determining the final order relation among all the work items. The detail of the operation of performing the strongly connected component decomposition to determine the final order relation among all the work items is as described above. The output unit 109 outputs the order relation among all the work items determined by the decider 108 (decomposer 108e) in a form of a check sheet, a sequence diagram, or a flowchart, for example. The order relation determination is then finished.

FIGS. 16A and 16B illustrate examples where the output unit 109 outputs the order relation among all the work items determined by the decider 108 in a form of a flowchart. FIG. 16A illustrates an example where the output unit 109 outputs the order relation among all the work items decided by the decider 108 in a form of a flowchart only with the work items obtained by performing the setting of the past, the present, and the future and the setting of the temporal anteroposterior relation between the work items by the setter 106 on the text of the troubleshooting having ID “0001” in the maintenance log illustrated in FIG. 5. FIG. 16B illustrates an example where the output unit 109 outputs the order relation among all the work items decided by the decider 108 in a form of a flowchart only with the work items obtained by performing the setting of the past, the present, and the future and the setting of the temporal anteroposterior relation between the work items by the setter 106 on the text of the troubleshooting having ID “0002” in the maintenance log illustrated in FIG. 5.

If the counter 107 performs the counting of the anteroposterior relation on the work state database, the decider 108 may directly perform the determination of the order relation among all the work items using the score at Step S35 without performing the processing from Step S31 to Step S34, for example.

The work supporting device 10 of the work supporting system 1 performs the processing described above. The work supporting device 10 specifies the work items from the maintenance log in which text including orthographic variations is written by the operator or other workers or an apparatus to be subjected to maintenance, for example. The work supporting device 10 distinguishes the work items that can be collectively performed at a time from the work items one of which needs to be performed first out of all the specified work items. Consequently, the work supporting device 10 can determine the optimum order relation among the work items as a whole.

The work supporting device 10 outputs (displays and outputs as an image or outputs as a printed material) the determined optimum order relation among all the work items in a form of a check sheet, a sequence diagram, or a flowchart, for example. This mechanism enables the operator to check the order of the work items in advance and perform the work in accordance with the order of the work items indicated by the output information in maintenance work performed on the apparatus to be subjected to the maintenance (e.g., the equipment 21 illustrated in FIG. 1).

It is not always optimal that the order of the work items is changed only based on history information, such as the frequency and the field of the generated work, because a trouble is not always solved in maintenance or inspection, for example. The present embodiment counts the temporal anteroposterior relation between each pair of the work items out of all the specified work items and finally determines the order relation among all the work items based on the number of counts. Consequently, the obtained order relation among the work items is highly reliable.

FIGS. 7, 10, 11, 16A, 16B and other figures illustrate an example where the work supporting device 10 performs the natural language processing, the work item specification, the anteroposterior relation setting, and the order relation determination on the text of the troubleshooting having IDs “0001” and “0002” in the maintenance log illustrated in FIG. 5. As illustrated in the maintenance log in FIG. 5, however, the text of the troubleshooting are written in units of troubles and units of apparatuses. As a result, typical text of troubleshooting has no connection between the troubles or the apparatuses in most cases. Consequently, the work supporting device 10 preferably performs the natural language processing, the work item specification, the anteroposterior relation setting, the counting on the work state database, and the order relation determination in units of troubles and units of apparatuses. With this mechanism, the work supporting device 10 can output the order of the work items appropriately in units of troubles and units of apparatuses.

The present embodiment performs the setting of only the past, the present, and the future with reference to the date and time when the maintenance information is written in the maintenance log. The present embodiment can set how many hours earlier, not just in the past, the work items are finished and how many hours later, not just in the future, the work items are performed by comparing the anteroposterior relation between the records in the maintenance log. In this case, the work state database may store therein not only the counts of the temporal anteroposterior relation between the work items but also the time interval between the work items. The time interval between the work items may be reflected to the order relation setting to be performed later. The present embodiment can consider a waiting time between the work items as the score besides the score relating to the anteroposterior relation between the work items, for example. With this mechanism, the present embodiment can determine not only the order relation among all the work items but also the waiting time between the work items. Consequently, the present embodiment can provide a more detailed work procedure.

The computer programs executed by the work supporting device 10 and the user PC 20 according to the embodiment above may be embedded in advance and provided in a ROM, for example.

The computer programs executed by the work supporting device 10 and the user PC 20 according to the embodiment above may be recorded in a computer-readable recording medium, such as a CD-ROM, a flexible disc (FD), a CD-R, and a DVD, as an installable or executable file and provided as a computer program product.

The computer programs executed by the work supporting device 10 and the user PC 20 according to the embodiment above may be stored in a computer connected to a network, such as the Internet, and provided by being downloaded via the network. Furthermore, the computer programs executed by the work supporting device 10 and the user PC 20 according to the embodiment above may be provided or distributed via a network, such as the Internet.

The computer programs executed by the work supporting device 10 and the user PC 20 according to the embodiment above can cause a computer to serve as the functional units described above. The computer can cause a CPU to read and execute the computer programs from a computer-readable storage medium on a main memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A work supporting system comprising:
a specification system implemented by one or more hardware processors and configured to identify work items from a maintenance log to which a work content is written as text;
a configuration system implemented by one or more hardware processors and configured to establish an anteroposterior relation between the work items based on a clue expression indicating time and the anteroposterior relation in the text within a threshold distance of the work items identified by the specification system; and
a decision engine implemented by one or more hardware processors and configured to determine an order relation among the work items based on the anteroposterior relation established by the configuration system.

2. The system according to claim 1, further comprising an analyzer implemented by one or more hardware processors and configured to perform a natural language processing on the text written to the maintenance log, wherein
the specification system identifies a work item from the text on which the natural language processing is performed by the analyzer.

3. The system according to claim 2, wherein
the specification system
extracts a word string matching a particular pattern as a keyword candidate from the text on which the natural language processing is performed by the analyzer,
obtains a statistic of the keyword candidate,
calculates a likelihood of the keyword candidate based on the statistic, and
specifies the keyword candidate as the work item based on the likelihood.

4. The system according to claim 1, wherein
the configuration system
retrieves a first clue expression indicating time from the text within the threshold distance of the work item identified by the specifier,
sets the time indicated by the retrieved clue expression to the work item,
retrieves a second clue expression indicating a temporal anteroposterior relation from the text within the threshold distance of the work item to which the time is set, and
sets the anteroposterior relation indicated by the retrieved clue expression to the work item.

5. The system according to claim 1, further comprising a counter configured to count the anteroposterior relation between the work items established by the configuration system for each pair of the work items, wherein
the decision engine determines the order relation among the work items based on the number of counts of each pair of the work items counted by the counter.

6. The system according to claim 5, wherein
the decision engine
determines whether the anteroposterior relation between each pair of the work items is uniquely determined based on the number of counts, and
performs, when the anteroposterior relation between all pairs of the work items is uniquely determined, strongly connected component decomposition on the work items to determine the order relation among the work items.

7. The system according to claim 5, wherein
the decision engine
determines whether the anteroposterior relation between each pair of the work items is uniquely determined based on the number of counts,
calculates, when the anteroposterior relation between all pairs of the work items is not uniquely determined, a total of frequencies relating to the anteroposterior relation between the work items for each permutation of the work items as a score, and
selects the permutation of the work items having an optimum score as the order relation among the work items.

8. The system according to claim 1, wherein
the configuration system sets a time interval between the work items based on the clue expression, and
the decision engine determines the order relation among the work items and a waiting time between the work items based on the anteroposterior relation and the time interval set by the configuration system.

9. The system according to claim 1, further comprising a user interface system implemented by one or more hardware processors and configured to output information indicating the order relation among the work items determined by the decision engine.

10. A work supporting method comprising:
identifying work items from a maintenance log to which a work content is written as text;
establishing an anteroposterior relation between the work items based on a clue expression indicating time and the anteroposterior relation in the text within a threshold distance of the identified work items; and
determine an order relation among the work items based on the set anteroposterior relation.

11. A computer program product having a non-transitory computer readable medium including programmed instructions, wherein the instructions, when executed by a computer, cause the computer to perform operations comprising:
identifying work items from a maintenance log to which a work content is written as text;
establishing an anteroposterior relation between the work items based on a clue expression indicating time and the anteroposterior relation in the text within a threshold distance of the identified work items; and
determining an order relation among the work items based on the set anteroposterior relation.
